(19) United States
(12) Patent Application Publication
(10) Pub. No.: US 2025/0264730 A1
(43) Pub. Date: Aug. 21, 2025

(54) TILED DISPLAY DEVICE AND IMAGE DISPLAY METHOD THEREOF

(71) Applicant: SAMSUNG DISPLAY CO., LTD., YONGIN-SI (KR)

(72) Inventor: YOUNG SANG HA, Yongin-si (KR)

(21) Appl. No.: 18/977,808

(22) Filed: Dec. 11, 2024

(30) Foreign Application Priority Data
Feb. 21, 2024 (KR) 10-2024-0025111

(51) Int. Cl. G02B 30/27; H04N 13/305; H04N 13/351

(52) U.S. Cl. CPC G02B 30/27; H04N 13/305; H04N 13/351

(57) ABSTRACT

A tiled display device includes a display panel having a plurality of pixels, a seam area disposed between first, second, third, and fourth groups of the pixels, an optical panel disposed on the display panel, and a controller configured output a background image to the pixels that are spaced apart from the seam area having a first depth and output a target image to the pixels that are adjacent the seam area having a second depth different from the first depth.

### CROSS-REFERENCE TO RELATED APPLICATION

The present US patent application claims priority under 35 U.S.C. § 119(a) to Korean patent application No. 10-2024-0025111, filed on Feb. 21, 2024, in the Korean Intellectual Property Office, the disclosure of which is incorporated by reference in its entirety herein.

### 1. Technical Field

The present disclosure is generally directed to a tiled display device and an image display method thereof.

### 2. Discussion of Related Art

A display device is a connection medium between a user and information. Examples of the display device include a liquid crystal display device and an organic light emitting display device.

A display device may provide a three-dimensional (3D) effect to a user of the display device by simulating a visual sense of the user to be similar to a real object. An image capable of providing the 3D effect to the user may be referred to as a stereoscopic image or a 3D image.

A planar image output from the display device may be recognized by the user as a 3D image. For example, the display device may provide different images to left and right eyes of the user of the display device. The user may observe an image in 3D due to a binocular parallax between the left and right eyes.

A user may observe a 3D image without wearing 3D glasses on a glass-free type of display device. The glass-free type may be a lenticular type in which a left eye image and a right eye image are separated from each other by using a cylindrical lens array or a barrier type in which a left eye image and a right eye image are separated from each other by using a barrier.

A tile type display device may present images perceived by users as 3D images. In a tile type display device, individual display units referred to as tiles are used to create a larger, cohesive display. Each tile presents a portion of the overall image or information to be displayed. When the tiles are assembled, the goal is to minimize the visibility of gaps to create a seamless image. Despite advances in technology, the seam between tiles is sometimes visible and this can detract from the visual experience.

### SUMMARY

Embodiments provide a tiled display device and an image display method thereof, which can reduce a phenomenon in which an area of a seam is visible.

In accordance with an aspect of the present disclosure, there is provided a tiled display device including: a first unit pixel and a second unit pixel. The first unit pixel is for displaying a background image having a first depth on a seam area. The second unit pixel is for displaying a target image having a second depth different from the first depth.

The tiled display device may include a plurality of display devices. The seam area may be located between the plurality of display devices. At least one of the plurality of display devices may include the first unit pixel and the second unit pixel.

Each of the plurality of display devices may include: a display panel and an optical panel. The display panel may have a plurality of pixels. The optical panel may be located on the display panel. The optical panel may include a plurality of lenses.

Each of the first unit pixel and the second unit pixel may include at least one of the plurality of pixels.

The tiled display device may further include a host system configured to control the plurality of display devices. The host system may control a pixel included in the first unit pixel among the plurality of pixels to display the background image having the first depth, and control a pixel included in the second unit pixel among the plurality of pixels to display the target image having the second depth.

At least one of the plurality of display devices may include a plurality of first unit pixels including the first unit pixel and a plurality of second unit pixels including the second unit pixel. An average distance between the plurality of first unit pixels and the seam area may be smaller than an average distance between the plurality of second unit pixels and the seam area.

The tiled display device may further include a third unit pixel displaying a background image having a third depth different from the first and second depths in an area spaced apart from the seam area.

Another of the plurality of display devices may include the third unit pixel.

The third depth may be 0.

A distance between the first unit pixel and the seam area may be smaller than a distance between the third unit pixel and the seam area.

In accordance with another aspect of the present disclosure, there is provided an image display method of a tiled display device. The image display method includes: displaying, by a first unit pixel, a background image having a first depth on a seam area; and displaying, by a second unit pixel, a target image having a second depth different from the first depth.

The tiled display device may include a plurality of display devices. The seam area may be located between the plurality of display devices.

In the displaying of the background image having the first depth, a host system may control a pixel included in the first unit pixel to display the background image having the first depth. In the displaying of the target image having the second depth, the host system may control a pixel included in the second unit pixel to display the target image having the second depth.

The first depth may be smaller than the second depth.

The image display method may further include displaying, by a third unit pixel, a background image having a third depth different from the first and second depths in an area spaced apart from the seam area.

The third depth may be 0.

In accordance with an aspect of the present disclosure, there is provided a tiled display device including: a display panel having a plurality of pixels; an optical panel disposed on the display panel; and a controller configured to output a background image to the pixels that are spaced apart from the seam area having a first depth and output a target image to the pixels that are adjacent the seam area having a second depth different from the first depth.

The seam area may not include any pixel. The optical panel may include at least one optical lens to enable the background image and the target image to be perceived as three-dimensional (3D) images. The first depth may be smaller than the second depth.

### BRIEF DESCRIPTION OF THE DRAWINGS

FIG. 1 is a conceptual view of a display device in accordance with an embodiment of the present disclosure.

FIG. 2 is a plan view illustrating a display device in accordance with an embodiment of the present disclosure.

FIG. 3 is an exemplary view illustrating an example of a pixel shown in FIG. 2.

FIG. 4 is a plan view illustrating a tiled display device including a plurality of display devices in accordance with an embodiment of the present disclosure.

FIG. 5 is an enlarged layout view illustrating in detail area AR1 shown in FIG. 4.

FIG. 6 is an enlarged layout view illustrating in detail area AR2 shown in FIG. 4.

FIG. 7 is a block diagram illustrating a tiled display device in accordance with an embodiment of the present disclosure.

FIG. 8 is a view illustrating that a 3D image is displayed at one viewpoint by the display device shown in FIG. 1 in accordance with an embodiment of the present disclosure.

FIG. 9 is an example of a background image and a target image, which are displayed in the tiled display device in accordance with an embodiment of the present disclosure.

FIG. 10 is an example of unit pixels displaying the background image shown in FIG. 9.

FIG. 11 is an example of unit pixels displaying the target image shown in FIG. 9.

FIG. 12 is an embodiment of an image display method of the tiled display device in accordance with an embodiment of the present disclosure.

FIGS. 13 to 15 are views illustrating that an area in which a target image is displayed is changed according to progress of frames.

FIGS. 16 and 17 are views illustrating unit pixels displaying a background image and a target image in a first frame.

FIGS. 18 and 19 are views illustrating unit pixels displaying the background image and the target image in a second frame.

FIGS. 20 and 21 are views illustrating unit pixels displaying the background image and the target image in a third frame.

FIG. 22 is another example of the image display method of the tiled display device in accordance with an embodiment of the present disclosure.

FIG. 23 is an embodiment of a unit pixel.

### DETAILED DESCRIPTION

Hereinafter, exemplary embodiments are described in detail with reference to the accompanying drawings so that those skilled in the art may practice the present disclosure. The present disclosure may be implemented in various different forms and is not limited to the exemplary embodiments described in the present specification.

A part irrelevant to the description may be omitted to clearly describe the present disclosure, and the same or similar constituent elements will be designated by the same reference numerals throughout the specification. Therefore, the same reference numerals may be used in different drawings to identify the same or similar elements.

In addition, each component is illustrated in the drawings having a certain size or thickness, the present disclosure is not limited thereto. In description, the expression “equal” may mean “substantially equal.” That is, this may mean equality to a degree to which those skilled in the art can understand the equality. Other expressions may be expressions in which “substantially’ is omitted. As used herein, the singular forms are intended to include the plural forms as well, unless the context clearly indicates otherwise.

Hereinafter, exemplary embodiments of the present disclosure will be described in detail with reference to the accompanying drawings.

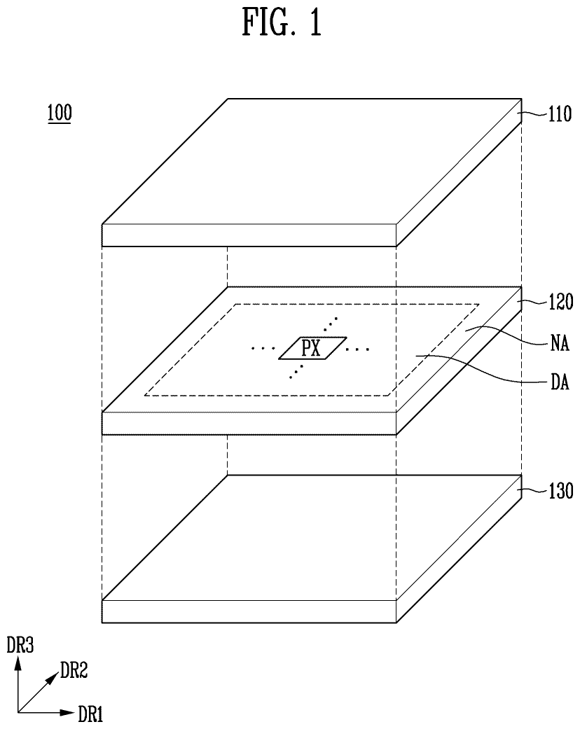

FIG. 1 is a conceptual view of a display device 100 in accordance with an embodiment of the present disclosure.

The display device 100 in accordance with an embodiment of the present disclosure includes an optical panel 110, a display panel 120 and a back cover 130.

The optical panel 110 may be configured to control an intensity and a direction of light emitted from the display panel 120. The optical panel 110 may include at least one lens. A user of the display device 100 may recognize an image emitted from the display panel 120 as a 3D image due to the presence of the at least one lens.

The display panel 120 may include a display area DA and a non-display area NA located at the periphery of the display area DA (e.g., an edge area of the display area DA). The display area DA may extend in a first direction DR1 and a second direction DR2 intersecting the first direction DR1. The display panel 120 may include a plurality of pixels PX. Each of the plurality of pixels PX may include a plurality of sub-pixels. Each of the plurality of pixels PX may emit light in a predetermined wavelength band. The plurality of pixels PX may be arranged in the display area DA. For example, a plurality of pixels PX arranged along the first direction DR1 may constitute a pixel row. For example, a plurality of pixels PX arranged along the second direction DR2 may constitute a pixel column.

The display panel 120 in accordance with the embodiments of the present disclosure may include a light emitting layer configured to generate light and emit the generated light. The light emitting layer may include, for example, an organic light emitting layer, a quantum dot or an inorganic light emitting layer. According to a kind of the light emitting layer included in the display panel 120, the display device 100 may be implemented as a self-luminous display device such as an organic light emitting display device, a quantum dot display device, or an inorganic light emitting display device.

The display panel 120 in accordance with the embodiments of the present disclosure may be configured to allow light incident from the outside to be selectively emitted therefrom without directly generating light. For example, the display device 100 in accordance with the embodiments of the present disclosure may include a light source (e.g., a backlight unit) outside of the display panel 120. The display panel 120 may include, for example, liquid crystals configured to control the intensity of light emitted from the display panel 120. The display panel 120 may control the intensity of light emitted from display panel 120 by adjusting a tilting angle of the liquid crystals. In an embodiment in which the display panel 120 does not include the light emitting layer, the display device 100 may be implemented as a passive light emitting display device.

Hereinafter, for convenience of description, an embodiment in which the display device 100 is a self-luminous display device is described as an example. However, embodiments of the present disclosure are not limited thereto.

The sub-pixel may include a light emitting element and a pixel circuit for driving the light emitting element. The pixel circuit may include, for example, two or more transistors and at least one capacitor.

The display panel 120 may include a substrate, a thin film transistor layer in which the pixel circuit is formed, and a light emitting element layer in which the light emitting element is located. The substrate may include a glass substrate or an organic/inorganic complex material substrate. The substrate may support the thin film transistor layer and the light emitting element layer.

A panel driving circuit for supplying various signals and/or various voltages, which are used to drive the pixels PX, may be further connected to the display panel 120. The panel driving circuit may be connected (e.g., electrically connected) to a pad portion, provided in the non-display area NA of the display panel 120, to supply signals and voltages to the display panel 120.

The back cover 130 may be located on a back surface of the display panel 120. The panel driving circuit connected to the display panel 120 may be accommodated in the back cover 130. In some embodiments, when at least a portion of the panel driving circuit is bent to the back surface of the display panel 120, the panel driving circuit may be accommodated in the back cover 130. In some embodiments, the back cover 130 is omitted.

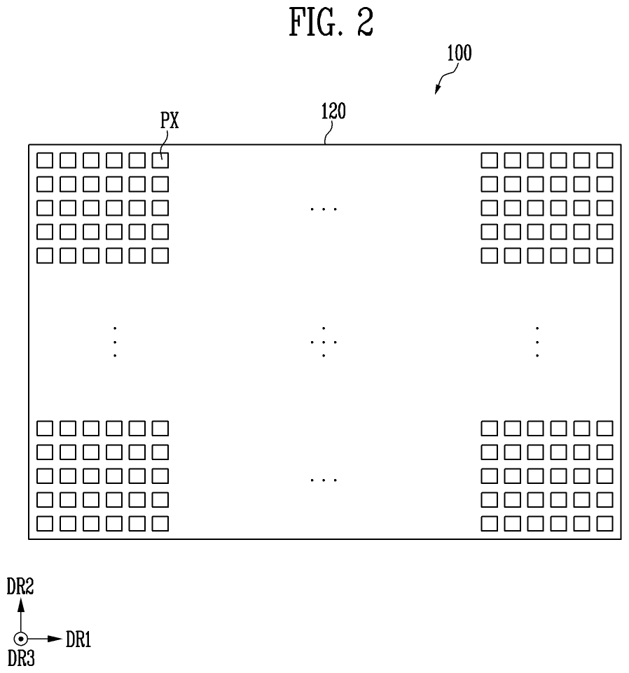

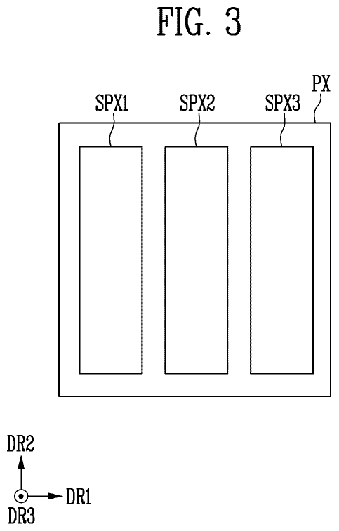

FIG. 2 is a plan view illustrating a display device 100 in accordance with an embodiment of the present disclosure. FIG. 3 is an exemplary view illustrating an example of a pixel PX shown in FIG. 2.

Referring to FIG. 2, the display device 100 is a device which displays a moving image or a still image, and may be used as a display screen of not only portable electronic devices such as a mobile phone, a smart phone, a tablet personal computer (PC), a mobile communication terminal, an electronic notebook, an electronic book, a portable multimedia player (PMP), a navigation system, and an ultra-mobile PC, but also various products such as a television, a notebook computer, a monitor, an advertisement board, and Internet of Things (IOT) device.

A display panel 120 may be formed in a rectangular plane having long sides in the first direction DR1 and short sides in the second direction DR2 intersecting the first direction DR1. A corner at which the long side in the first direction DR1 and the short side in the second direction DR2 meet each other may be rounded to have a predetermined curvature or shaped to have a right angle. The planar shape of the display panel 120 is not limited to a quadrangular shape, and the display panel 120 may be formed in another polygonal shape, a circular shape, or an elliptical shape. The display panel 120 may be formed to be flat, but the present disclosure is not limited thereto. For example, the display panel 120 may include a curved part which is formed at a left/right end and has a constant curvature or a changing curvature. In addition, the display panel 120 may be formed to be flexible enough to be wrappable, curvable, bendable, foldable or rollable.

The display panel 120 may further include pixels PX for displaying an image, a plurality of scan lines extending in the first direction DR1, and a plurality of data lines extending in the second direction DR2. The pixels PX may be arranged in a matrix form in the first direction DR1 and the second direction DR2. The first direction DR1 and the second direction DR2 may be directions orthogonal to each other (e.g., an x axis in a horizontal direction and a y axis in a vertical direction), but the present disclosure is not limited thereto.

Each of the pixels PX may include a plurality of sub-pixels SPX1, SPX2, and SPX3 as shown in FIG. 3. In FIG. 3, it is exemplified that the pixel PX includes three sub-pixels SPX1, SPX2, and SPX3, i.e., a first sub-pixel SPX1, a second sub-pixel SPX2, and a third sub-pixel SPX3. However, embodiments of the present disclosure are not limited thereto.

Each of the first sub-pixel SPX1, the second sub-pixel SPX2, and the third sub-pixel SPX3 may be electrically connected to any one data line among the plurality of data lines, and be electrically connected to at least one scan line among the plurality of scan lines.

Each of the first sub-pixel SPX1, the second sub-pixel SPX2, and the third sub-pixel SPX3 may have a rectangular, square or rhombic planar shape. For example, each of the first sub-pixel SPX1, the second sub-pixel SPX2, and the third sub-pixel SPX3 may have a rectangular planar shape having short sides in the first direction DR1 and long sides in the second direction DR2 as shown in FIG. 3. Alternatively, unlike FIG. 3, each of the first sub-pixel SPX1, the second sub-pixel SPX2, and the third sub-pixel SPX3 may have a square or rhombic planar shape including sides having the same length in the first direction DR1 and the second direction DR2.

As shown in FIG. 3, the first sub-pixel SPX1, the second sub-pixel SPX2, and the third sub-pixel SPX3 may be arranged in the first direction DR1.

Alternatively, any one of the second sub-pixel SPX2 and the third sub-pixel SPX3 and the first sub-pixel SPX1 may be arranged in the first direction DR1, and the other of the second sub-pixel SPX2 and the third sub-pixel SPX3 and the first sub-pixel SPX1 may be arranged in the second direction DR2. For example, the first sub-pixel SPX1 and the second sub-pixel SPX2 may be arranged in the first direction DR1, and the first sub-pixel SPX1 and the third sub-pixel SPX3 may be arranged in the second direction DR2. Alternatively, any one of the first sub-pixel SPX1 and the third sub-pixel SPX3 and the second sub-pixel SPX2 may be arranged in the first direction DR1, and the other of the first sub-pixel SPX1 and the third sub-pixel SPX3 and the second sub-pixel SPX2 may be arranged in the second direction DR2. Alternatively, any one of the first sub-pixel SPX1 and the second sub-pixel SPX2 and the third sub-pixel SPX3 may be arranged in the first direction DR1, and the other of the first sub-pixel SPX1 and the second sub-pixel SPX2 and the third sub-pixel SPX3 may be arranged in the second direction DR2.

The first sub-pixel SPX1 may emit light in a first wavelength band. The second sub-pixel SPX2 may emit light in a second wavelength band. The third sub-pixel SPX3 may emit light in a third wavelength band. The light in the first wavelength band may be light in a red wavelength band. The light in the second wavelength band may be light in a green wavelength band. The light in the third wavelength band may be light in a blue wavelength band. The red wavelength band may be a wavelength band of about 600 nanometer (nm) to about 750 nm. The green wavelength band may be a wavelength band of about 480 nm to about 560 nm. The blue wavelength band may be a wavelength band of about 370 nm to about 460 nm. However, embodiments of the present disclosure are not limited thereto.

Each of the first sub-pixel SPX1, the second sub-pixel SPX2, and the third sub-pixel SPX3 may include an inorganic light emitting element having an inorganic semiconductor as a light emitting element emitting light. For example, the inorganic light emitting element may be a flip chip type micro light emitting diode (LED) (or referred to as a micro LED), but embodiments of the present disclosure are not limited thereto.

As shown in FIG. 3, an area of the first sub-pixel SPX1, an area of the second sub-pixel SPX2, and an area of the third sub-pixel SPX3 may be substantially the same. However, embodiments of the present disclosure are not limited thereto. At least one of the area of the first sub-pixel SPX1, the area of the second sub-pixel SPX2, and the area of the third sub-pixel SPX3 may be different from another of the area of the first sub-pixel SPX1, the area of the second sub-pixel SPX2, and the area of the third sub-pixel SPX3. Alternatively, any two of the area of the first sub-pixel SPX1, the area of the second sub-pixel SPX2, and the area of the third sub-pixel SPX3 may be substantially the same, and the other of the area of the first sub-pixel SPX1, the area of the second sub-pixel SPX2, and the area of the third sub-pixel SPX3 may be different from the two of the area of the first sub-pixel SPX1, the area of the second sub-pixel SPX2, and the area of the third sub-pixel SPX3. Alternatively, the area of the first sub-pixel SPX1, the area of the second sub-pixel SPX2, and the area of the third sub-pixel SPX3 may be different from one another.

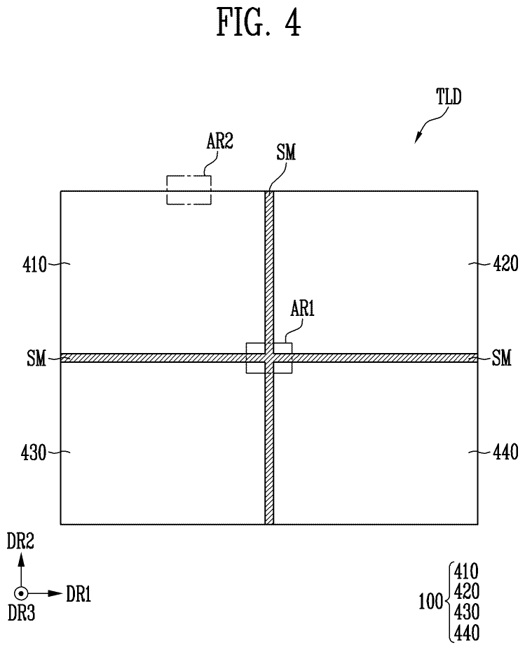

FIG. 4 is a plan view illustrating a tiled display device TLD including a plurality of display devices 410, 420, 430, and 440 in accordance with an embodiment of the present disclosure.

Referring to FIG. 4, the tiled display device TLD includes a plurality of display devices 410, 420, 430, and 440, and a seam area SM. For example, the tiled display device TLD may include a first display device 410, a second display device 420, a third display device 430, and a fourth display device 440.

The seam area SM may correspond to a boundary area between the plurality of display devices 410, 420, 430, and 440. The seam area SM may be an area in which the above-described pixel PX (see FIG. 2) is not located. Further referring to FIG. 1, the seam area SM may correspond to an area in which non-display areas NA are adjacent to each other. The seam area SM may be designated as a joint portion.

The plurality of display devices 410, 420, 430, and 440 may be arranged in a lattice form. The plurality of display devices 410, 420, 430, and 440 may be arranged in a matrix form of M (M is an integer of 1 or more) rows and N (N is an integer of 1 or more) columns. For example, the first display device 410 and the second display device 420 may be adjacent to each other in the first direction DR1. The first display device 410 and the third display device 430 may be adjacent to each other in the second direction DR2. The third display device 430 and the fourth display device 440 may be adjacent to each other in the first direction DR1. The second display device 420 and the fourth display device 440 may be adjacent to each other in the second direction DR2.

However, the number and arrangement of the plurality of display devices 410, 420, 430, and 440 in the tiled display device TLD are not limited to those shown in FIG. 4. The number and arrangement of the plurality of display devices 410, 420, 430, and 440 included in the tiled display device TLD may be differently set according to a size of each of the plurality of display devices 410, 420, 430, and 440 and the tiled display device TLD and a shape of the tiled display device TLD.

Referring to FIG. 4, it is illustrated that the plurality of display devices 410, 420, 430, and 440 have the same size. However, the present disclosure is not limited thereto. For example, at least one display device among the plurality of display devices 410, 420, 430, and 440 may have a size different from a size of the other display devices.

Each of the plurality of display devices 410, 420, 430, and 440 may have a rectangular shape including long sides and short sides. The plurality of display devices 410, 420, 430, and 440 may be disposed such that long sides or short sides are connected to each other. Some or all of the plurality of display devices 410, 420, 430, and 440 may be disposed at an edge of the tiled display device TLD, and form one side of the tiled display device TLD. At least one display device among the plurality of display devices 410, 420, 430, and 440 may be disposed at at least one corner of the tiled display device TLD, and form two adjacent sides of the tiled display device TLD. At least one display device among the plurality of display devices 410, 420, 430, and 440 may be surrounded by other display devices.

Each of the plurality of display devices 410, 420, 430, and 440 may be substantially identical to the display device 100 (see FIG. 1) described in conjunction with FIGS. 1 to 3. Therefore, descriptions of each of the plurality of display devices 410, 420, 430, and 440 will be omitted.

The seam area SM may include a coupling member or an adhesive member. The plurality of display devices 410, 420, 430, and 440 may be connected to each other through the coupling member or the adhesive member of the seam area SM. The seam area SM may be disposed between the first display device 410 and the second display device 420, between the first display device 410 and the third display device 430, between the second display device 420 and the fourth display device 440, and between the third display device 430 and the fourth display device 440.

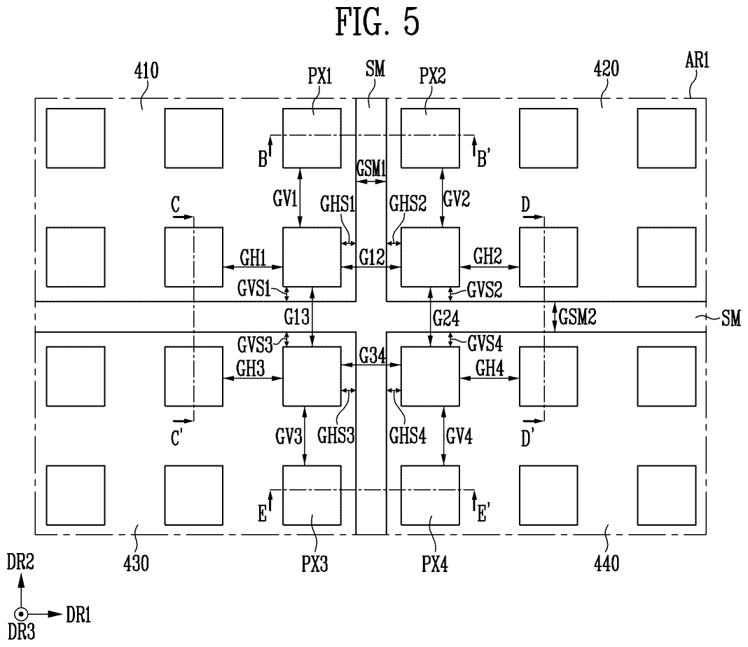

FIG. 5 is an enlarged layout view illustrating in detail area AR1 shown in FIG. 4.

Referring to FIG. 5, the seam area SM may have a planar shape of a cross or a plus sign in a central area of the tiled display device TLD, in which the first display device 410, the second display device 420, the third display device 430, and the fourth display device 440 are adjacent to each other.

The first display device 410 includes first pixels PX1 (or a first group of pixels) arranged in a matrix form in the first direction DR1 and the second direction DR2 to display an image. The second display device 420 includes second pixels PX2 (or a second group of pixels) arranged in a matrix form in the first direction DR1 and the second direction DR2 to display an image. The third display device 430 includes third pixels PX3 (or a third group of pixels) arranged in a matrix form in the first direction DR1 and the second direction DR2 to display an image. The fourth display device 440 includes fourth pixels PX4 (or a fourth group of pixels) arranged in a matrix form in the first direction DR1 and the second direction DR2 to display an image.

A minimum distance between the first pixels PX1 adjacent to each other in the first direction DR1 may be defined as a first horizontal separation distance GH1, and a minimum distance between the second pixels PX2 adjacent to each other in the first direction DR1 may be defined as a second horizontal separation distance GH2. The first horizontal separation distance GH1 and the second horizontal separation distance GH2 may be substantially the same.

The seam area SM may be disposed between a first pixel PX1 and a second pixel PX2, which are adjacent to each other in the first direction DR1. A minimum distance G12 between the first pixel PX1 and the second pixel PX2, which are adjacent to each other in the first direction DR1, may be a sum of a minimum distance GHS1 between the first pixel PX1 and the seam area SM in the first direction DR1, a minimum distance GHS2 between the second pixel PX2 and the seam area SM in the first direction DR1, and a width GSM1 of the seam area SM in the first direction DR1.

The minimum distance G12 between the first pixel PX1 and the second pixel PX2, which are adjacent to each other in the first direction DR1, the first horizontal separation distance GH1, and the second horizontal separation distance GH2 may be substantially the same. In an embodiment, the minimum distance GHS1 between the first pixel PX1 and the seam area SM in the first direction DR1 is smaller than the first horizontal separation distance GH1, and the minimum distance GHS2 between the second pixel PX2 and the seam area SM in the first direction DR1 is smaller than the second horizontal separation distance GH2. In addition, the width GSM1 of the seam area SM in first direction DR1 may be smaller than the first horizontal separation distance GH1 or the second horizontal separation distance GH2.

A minimum distance between third pixels PX3 adjacent to each other in the first direction DR1 may be defined as a third horizontal separation distance GH3, and a minimum distance between fourth pixels PX4 adjacent to each other in the first direction DR1 may be defined as a fourth horizontal separation distance GH4. The third horizontal separation distance GH3 and the fourth horizontal separation distance GH4 may be substantially the same.

The seam area SM may be disposed between a third pixel PX3 and a fourth pixel PX4, which are adjacent to each other in the first direction DR1. A minimum distance G34 between the third pixel PX3 and the fourth pixel PX4, which are adjacent to each other in the first direction DR1, may be a sum of a minimum distance GHS3 between the third pixel PX3 and the seam area SM in the first direction DR1, a minimum distance GHS4 between the fourth pixel PX4 and the seam area SM in the first direction DR1, and the width GSM1 of the seam area SM in the first direction DR1.

The minimum distance G34 between the third pixel PX3 and the fourth pixel PX4, which are adjacent to each other in the first direction DR1, the third horizontal separation distance GH3, and the fourth horizontal separation distance GH4 may be substantially the same. In an embodiment, the minimum distance GHS3 between the third pixel PX3 and the seam area SM in the first direction DR1 is smaller than the third horizontal separation distance GH3, and the minimum distance GHS4 between the fourth pixel PX4 and the seam area SM in the first direction DR1 is smaller than the fourth horizontal separation distance GH4. In addition, the width GSM1 of the seam area SM in first direction DR1 may be smaller than the third horizontal separation distance GH3 or the fourth horizontal separation distance GH4.

A minimum distance between first pixels PX1 adjacent to each other in the second direction DR2 may be defined as a first vertical separation distance GV1, and a minimum distance between third pixels PX3 adjacent to each other in the second direction DR2 may be defined as a third vertical separation distance GV3. The first vertical separation distance GV1 and the third vertical separation distance GV3 may be substantially the same.

The seam area SM may be disposed between a first pixel PX1 and a third pixel PX3, which are adjacent to each other in the second direction DR2. A minimum distance G13 between the first pixel PX1 and the third pixel PX3, which are adjacent to each other in the second direction DR2, may be a sum of a minimum distance GVS1 between the first pixel PX1 and the seam area SM in the second direction DR2, a minimum distance GVS3 between the third pixel PX3 and the seam area SM in the second direction DR2, and a width GSM2 of the seam area SM in the second direction DR2.

The minimum distance G13 between the first pixel PX1 and the third pixel PX3, which are adjacent to each other in the second direction DR2, the first vertical separation distance GV1, and the third vertical separation distance GV3 may be substantially the same. In an embodiment, the minimum distance GVS1 between the first pixel PX1 and the seam area SM in the second direction DR2 is smaller than the first vertical separation distance GV1, and the minimum distance GVS3 between the third pixel PX3 and the seam area SM in the second direction DR2 is smaller than the third vertical separation distance GV3. In addition, the width GSM2 of the seam area SM in the second direction DR2 may be smaller than the first vertical separation distance GV1 or the third vertical separation distance GV3.

A minimum distance between second pixels PX2 adjacent to each other in the second direction DR2 may be defined as a second vertical separation distance GV2, and a minimum distance between fourth pixels PX4 adjacent to each other in the second direction DR2 may be defined as a fourth vertical separation distance GV4. The second vertical separation distance GV2 and the fourth vertical separation distance GV4 may be substantially the same.

The seam area SM may be disposed between a second pixel PX2 and a fourth pixel PX4, which are adjacent to each other in the second direction DR2. A minimum distance G24 between the second pixel PX2 and the fourth pixel PX4, which are adjacent to each other in the second direction DR2, may be a sum of a minimum distance GVS2 between the second pixel PX2 and the seam area SM in the second direction DR2, a minimum distance GVS4 between the fourth pixel PX4 and the seam area SM in the second direction DR2, and the width GSM2 of the seam area SM in the second direction DR2.

The minimum distance G24 between the second pixel PX2 and the fourth pixel PX4, which are adjacent to each other in the second direction DR2, the second vertical separation distance GV2, and the fourth vertical separation distance GV4 may be substantially the same. In an embodiment, the minimum distance GVS2 between the second pixel PX2 and the seam area SM in the second direction DR2 is smaller than the second vertical separation distance GV2, and the minimum distance GVS4 between the fourth pixel PX4 and the seam area SM in the second direction DR2 is smaller than the fourth vertical separation distance GV4. In addition, the width GSM2 of the seam area SM in the second direction DR2 may be smaller than the second vertical separation distance GV2 or the fourth vertical separation distance GV4.

As shown in FIG. 5, to reduce the seam area SM viewed between images displayed by the plurality of display devices 410, 420, 430, and 440, a minimum distance between pixels of display devices adjacent to each other may be substantially the same as a minimum distance between pixels of each of the display devices. However, embodiments of the present disclosure are not limited thereto.

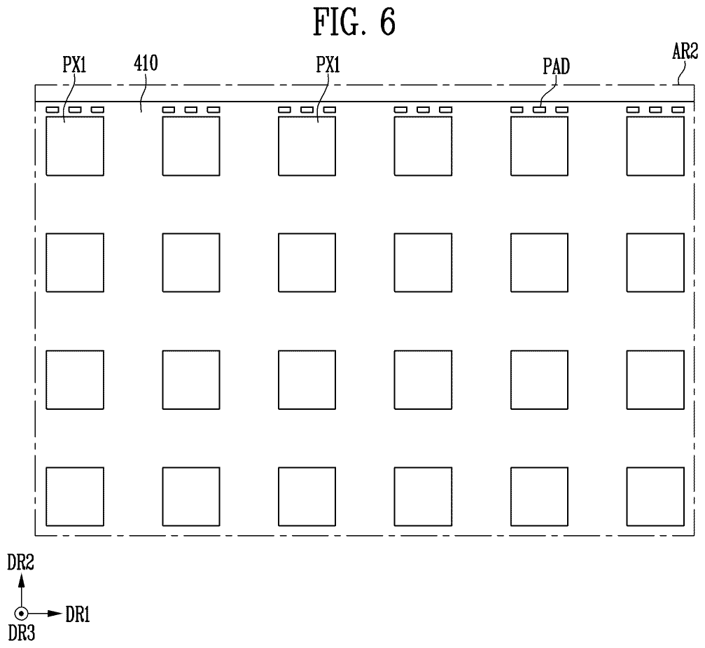

FIG. 6 is an enlarged layout view illustrating in detail area AR2 shown in FIG. 4.

In FIG. 6, pads PAD disposed at an upper side of the first display device 410 and first pixels PX1 are illustrated.

Referring to FIG. 6, at least pad PAD may be disposed at an upper edge of the first display device 410. When data lines of the first display device 410 extend in the second direction DR2, the pad PAD may be disposed at the upper edge and/or a lower edge of the first display device 410. Alternatively, when the data lines of the first display device 410 extend in the first direction DR1, the pad PAD may be disposed at a left edge and/or a right edge of the first display device 410.

The pad PAD may be electrically connected to a data line. Also, the pad PAD may be electrically connected to a side line.

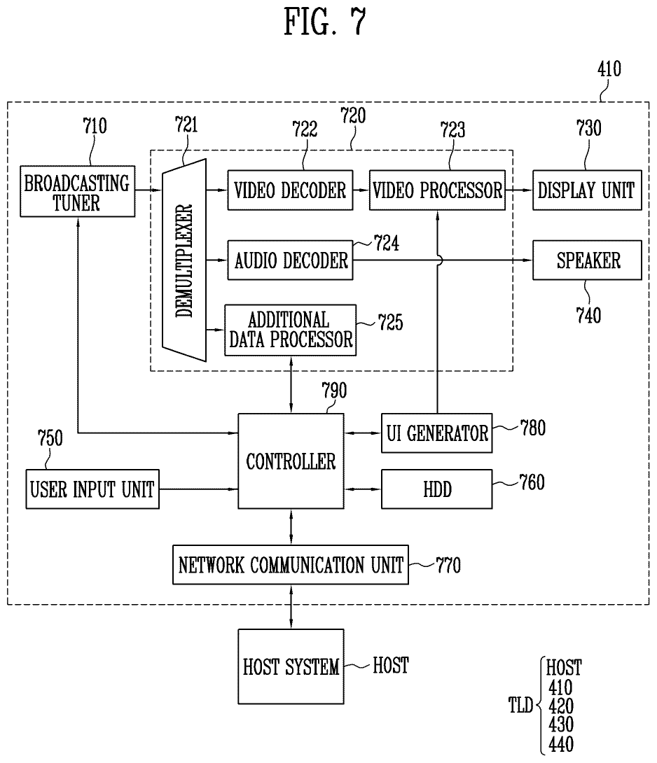

FIG. 7 is a block diagram illustrating a tiled display device TLD in accordance with an embodiment of the present disclosure.

Referring to FIG. 7, the tiled display device TLD in accordance with the embodiments of the present disclosure includes a host system HOST and a plurality of display devices 410, 420, 430, and 440.

In FIG. 7, for convenience of description, it is illustrated that the host system HOST controls a first display device 410. However, the host system HOST may perform a function of controlling the plurality of display devices 410, 420, 430, and 440.

The host system HOST may be implemented as, for example, a set top box or an Application Processor (AP), but is not limited thereto.

A command of a user may be input in various forms to the host system HOST. For example, a command according to a touch input of the user may be input to the host system HOST. Alternatively, a command of the user according to an external input device (e.g., a keyboard input or a button input of a remote controller) may be input to the host system HOST.

The host system HOST may receive original video data corresponding to an original image, which is input from the outside. The host system HOST may divide the original video data into different portions of video data based on the number of the plurality of display devices 410, 420, 430, and 440. For example, the host system HOST may divide original video data into first video data corresponding to a first image for the first display device 410, second video data corresponding to a second image for a second display device 420, third video data corresponding to a third image for a third display device 430, and fourth video data corresponding to a fourth image for a fourth display device 440. The host system HOST may transmit the first video data to the first display device 410, transmit the second video data to the second display device 420, transmit the third video data to the third display device 430, and transmit the fourth video data to the fourth display device 440.

The first display device 410 may display the first image according to the first video data, the second display device 420 may display the second image according to the second video data, the third display device 430 may display the third image according to the third video data, and the fourth display device 440 may display the fourth image according to the fourth video data. Accordingly, the user can view an original image obtained by combining the first to fourth images displayed in the first to fourth display devices 410, 420, 430, and 440.

Referring to FIG. 7, the first display device 410 may include a broadcasting tuner 710, a signal processor 720, a display unit 730 (e.g., display device), a speaker 740, a user input unit 750 (e.g., user input device), a hard disk drive (HDD) 760, a network communication unit 770 (e.g., a network card or a network device), a user interface (UI) generator 780 and a controller 790.

The broadcasting tuner 710 may receive a broadcasting signal of a corresponding channel through an antenna by tuning a predetermined channel frequency under the control of the controller 790. The broadcasting tuner 710 may include a channel direction module and a radio frequency (RF) demodulation module.

A broadcasting signal demodulated by the broadcasting tuner 710 may be processed by the signal processor 720 to be output to the display unit 730 and the speaker 740. The signal processor 720 may include a demultiplexer 721, a video decoder 722, a video processor 723, an audio decoder 724 and an additional data processor 725.

The demultiplexer 721 separates the demodulated broadcasting signal into a video signal, an audio signal, and additional data. The video signal, the audio signal, and the additional data, which are separated, are respectively recovered by the video decoder 722, the audio decoder 724, and the additional data processor 725. The video decoder 722, the audio decoder 724, and the additional data processor 725 may recover the video signal, the audio signal, and the additional data in a decoding format corresponding to an encoding format when a broadcasting signal is transmitted.

The decoded video signal may be converted by the video processor 723 to conform with a vertical frequency, a resolution or a screen rate, which are suitable for output standards of the display unit 730, and the decoded audio signal may be output to the speaker 740.

The display unit 730 may include a display panel 120 (see FIG. 1) for displaying an image and a panel driver for controlling driving of the display panel 120.

The user input unit 750 may receive a signal transmitted from the host system HOST. The user input unit 750 may be provided to input not only data about selection of a channel transmitted from the host system HOST and selection and manipulation of a UI menu, but also data about that the user selects and inputs a command for communication with another display device.

The HDD 760 may be used to store various software programs including an operating system (OS) program, recorded broadcasting programs, moving images, pictures, and other data, and may be configured as a storage medium such as a hard disk or a nonvolatile memory. The HDD 760 may be designated as a storage unit.

The network communication unit 770 may be used to perform near field communication with the host system HOST and another display device, and may be implemented as a communication module including an antenna pattern capable of implementing mobile communication, data communication, Bluetooth, RF or Ethernet. The network communication unit 770 may transmit/receive a wireless signal of at least one of a base station, an external terminal, and a server on a mobile communication network according to a technical standard or communication scheme for mobile communication. For example, the network communication unit 770 may send signals supporting a global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTE-A), or 5G through an antenna pattern.

The network communication unit 770 may transmit/receive a wireless signal in a communication network according wireless Internet technologies through the antenna pattern. The wireless Internet technologies may include, for example, wireless LAN (WLAN), wireless-fidelity (Wi-Fi), Wi-Fi direct, digital living network alliance (DLNA), wireless broadband (WiBro), world interoperability for microwave access (WiMAX), high speed downlink packet access (HSDPA), high speed uplink packet access (HSUPA), long term evolution (LTE) or long term evolution-advanced (LTE-A). The antenna pattern may transmits/receive data according to at least one wireless Internet technology.

The UI generator 780 is used to generate a UI menu for communication with the host system HOST and another display device, and may be implemented by an algorithm code and an on screen display (OSD) integrated circuit (IC). The UI menu for communication with the host system HOST and another display device may be a menu for specifying a desired digital TV and selecting a desired function.

The controller 790 is used to take charge of overall control of the first display device 410 and to take charge of communication control of the host system HOST and the second to fourth display devices 420, 430, and 440. The controller 790 may be implemented by a micro control unit (MCU) in which a corresponding algorithm code for control is stored and executed.

The controller 790 controls a corresponding control command and corresponding data to be transmitted the host system HOST and the second to fourth display devices 420, 430, and 440 through the network communication unit 770 according to an input and selection of the user input unit 750. When a predetermined control command and predetermined data are input from the host system HOST and the second to fourth display devices 420, 430, and 440, an operation is performed according to the corresponding control command.

In an embodiment, a block diagram of the second display device 420, a block diagram of the third display device 430, and a block diagram of the fourth display device 440 are substantially identical to the block diagram of the first display device 410 described in conjunction with FIG. 7, and therefore, their descriptions will be omitted.

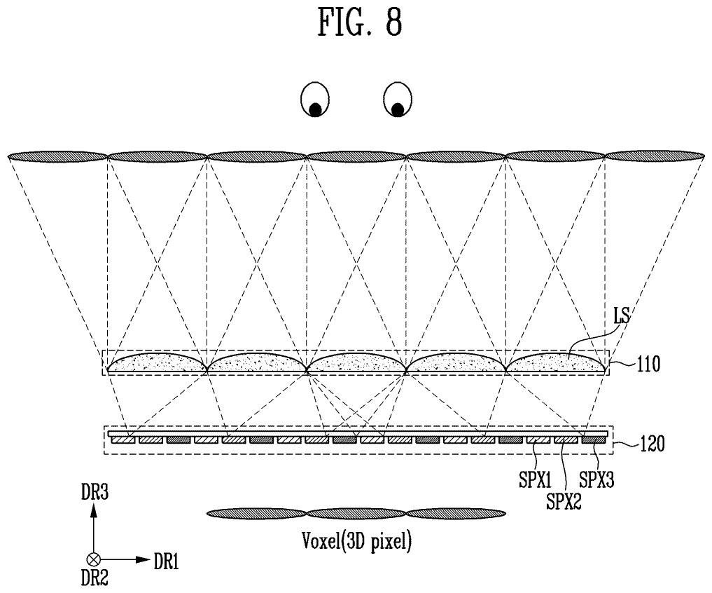

FIG. 8 is a view illustrating that a 3D image is displayed at one viewpoint by the display device 100 shown in FIG. 1 in accordance with an embodiment of the present disclosure.

The display panel 120 may include a plurality of sub-pixels SPX1, SPX2, and SPX3 which display an image by emitting light.

The optical panel 110 may be disposed above the display panel 120 (e.g., in an area in a third direction DR3 from the display panel 120). The optical panel 110 may include a plurality of lenses LS configured to refract light incident from the plurality of sub-pixels SPX1, SPX2, and SPX3. The plurality of lenses LS may constitute a lens array. The lens array may be implemented as, for example, a lenticular lens array or a micro lens array. The plurality of lenses LS may be disposed in the optical panel 110 while extending in the second direction DR2.

The display device 100 (see FIG. 1) in accordance with an embodiment of the present disclosure is implemented as a light field display. The light field display is a 3D display which implements a 3D image by forming a light field expressed with a vector distribution (intensity and direction) of light in a space, using a flat panel display (e.g., the display panel 120) and an optical element (e.g., a lens array of the optical panel 110). The light field display refers to a display technique in which a depth and a side of an object can be viewed, so that a more natural 3D image can be implemented, thereby enabling various uses through fusion with an Augmented Reality (AR) technique.

The light field may be implemented using various methods. For example, the light field may be formed using a method of making light fields in several directions, using several projectors, a method of controlling a direction of light, using a grating, a method of controlling a direction and an intensity (luminance) of light according to a combination of a plurality of sub-pixels SPX1, SPX2, and SPX3, using two or more panels, a method of controlling a direction of light, using a pinhole or a barrier or a method of controlling a refraction direction of light through a lens array.

In an embodiment, as shown in FIG. 8, the display device 100 (see FIG. 1) using a lens array method may form a light field, thereby displaying a stereoscopic image (3D image).

At least one sub-pixel (e.g., SPX1, SPX2, or SPX3) may be allocated to the lens LS of the optical panel 110. Light emitted from the sub-pixel may be refracted by the lens LS to advance in a specific direction, thereby forming a light field expressed with an intensity and a direction of the light. When the user of the display device 100 views the display device 100 (or the display panel 120) in the light field formed as described above, the user may perceive a 3D effect of a corresponding image.

Image information according to a viewpoint of a viewer within the light field may be defined and processed in units of voxels. The voxel may be understood as graphic information which defines a predetermined point (or pixel) in a 3D space. A resolution of a 2D image may be determined using a number (e.g., a density) of pixels (or sub-pixels SPX) with respect to the same area. For example, when the number of pixels (or sub-pixels SPX) with respect to the same area increases, the resolution may increase. That is, the display panel 120 having a high pixel density may be required to display a high-resolution image. Similarly, when the number of voxels at the same viewpoint through the optical panel 110 increases, the resolution of a 3D image may increase.

The plurality of lenses LS in the optical panel 110 may extend in one direction (e.g., the second direction DR2). Accordingly, the user of the display device 100 (see FIG. 1) at one viewpoint shown in FIG. 8 may perceive the 3D effect of an image.

Meanwhile, a 3D image may be displayed in an area having a width wider than a width of the lenses LS. For example, a width with which the 3D image is displayed in the first direction DR1 may be greater than a width of the optical panel 110 in the first direction DR1. Therefore, an image (or 3D image) may be displayed on the above-described seam area SM (see FIG. 4).

An image may be displayed with a predetermined depth from the display panel 120.

Referring to FIG. 8, a distance between a position at which a voxel is formed (e.g., a position at which a 3D image is formed) and the display panel 120 may correspond to a depth. The user may perceive a 3D effect according to a depth of an image. For example, when the user views an image having a large depth, the user may recognize as if the corresponding image is reproduced at a distance close to the user.

The depth may correspond to a distance between the user and a 3D image formed in a space by light emitted from the display panel 120. For example, when the user views an image having a small depth, the user may feel that the distance between the user and the 3D image is distant. Accordingly, the user may perceive as if the image is located at a relatively distant place. For example, when the user views an image having a large depth, the user may perceive that the distance between the user and the 3D image is close. Accordingly, the user may perceive as if the image is located at a relatively close place.

Further referring to FIG. 7 described above, according to an embodiment, the host system HOST adjusts a depth of an image displayed in each area of the plurality of display devices 410, 420, 430, and 440, and transmits data (e.g., image data) having the adjusted depth to each of the plurality of display devices 410, 420, 430, and 440.

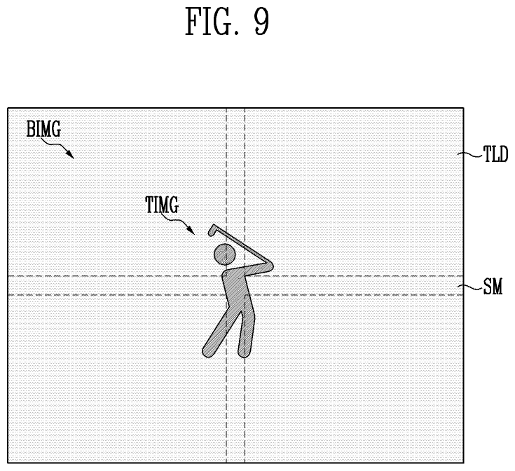

FIG. 9 is an example of a background image BIMG and a target image TIMG, which are displayed in the tiled display device TLD in accordance with an embodiment of the present disclosure.

Referring to FIG. 9, a background image BIMG and a target image TIMG may be displayed in the tiled display device TLD.

The background image BIMG may be displayed on at least a portion of the seam area SM. The target image TIMG may be displayed on at least a portion of the other area of the seam area SM. For example, the background image BIMG and the target image TIMG may be displayed on different parts of the seam area SM.

Accordingly, a phenomenon can be reduced, in which the seam area SM is directly viewed by the user since an image (or 3D image) is displayed on the seam area SM or perceived as appearing on the seam area SM.

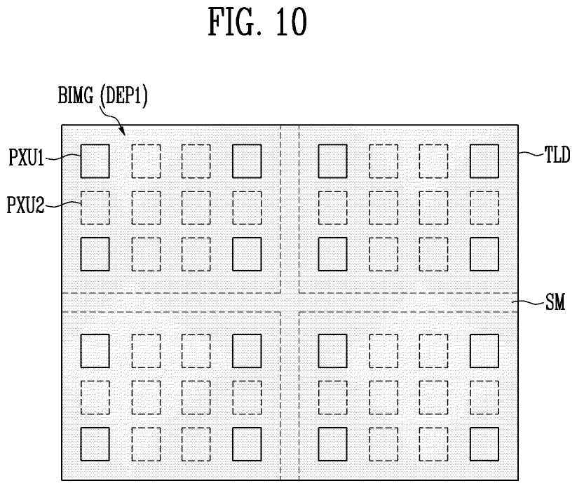

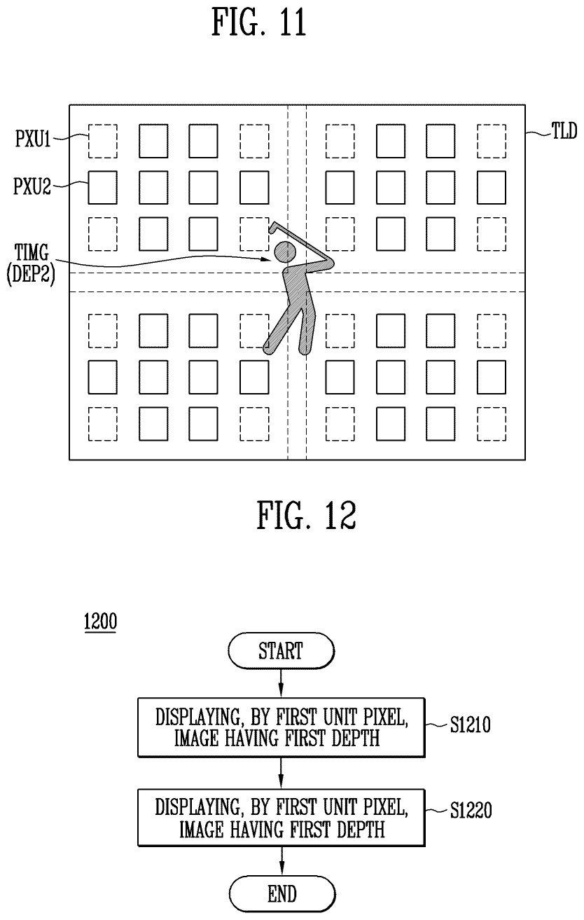

FIG. 10 is an example of unit pixels displaying the background image BIMG shown in FIG. 9. FIG. 11 is an example of unit pixels displaying the target image TIMG shown in FIG. 9.

Referring to FIG. 10, unit pixels may include a plurality of first unit pixels PXU1 and a plurality of second unit pixels PXU2.

In an embodiment, the first unit pixel PXU1 and the second unit pixel PXU2 have the same size. However, embodiments of the present disclosure are not limited thereto. For example, the first unit pixel PXU1 and the second unit pixel PXU2 may have different sizes.

The first unit pixel PXU1 may display the background image BIMG. In an embodiment, the first unit pixel PXU1 may include at least one pixel. In an embodiment, the first unit pixel PXU1 may include at least one sub-pixel.

The first unit pixel PXU1 may be located in a corner area or a vertex area of the display device 100 (see FIG. 4). In an embodiment, the first unit pixel PXU1 may be located in a central area of the display device 100.

The second unit pixel PXU2 may display the target image TIMG. In an embodiment, the second unit pixel PXU2 may include at least one pixel. In an embodiment, the second unit pixel PXU2 may include at least one sub-pixel.

The second unit pixel PXU2 may be located in a central area of the display device 100 (see FIG. 4). In an embodiment, the second unit pixel PXU2 may be located in a corner area or a vertex area of the display device 100.

In an embodiment, the first unit pixel PXU1 is located adjacent to the seam area SM. For example, a unit pixel located adjacent to the seam area SM may be one of a subset of pixels that are closest to the seam area SM. The second unit pixel PXU2 may be spaced apart from the seam area SM. For example, there may be intervening pixel present between the second unit pixel PXU2 and the seam area SM. In an embodiment, a distance (e.g., an average distance or a median value distance) between the plurality of first unit pixels PXU1 and the seam area SM is smaller than a distance (e.g., an average distance or a median value distance) between the plurality of second unit pixels PXU2 and the seam area SM.

In an embodiment, the first unit pixel PXU1 is controlled to display an image having a first depth DEP1. Referring to FIG. 10, the first unit pixel PXU1 may display the background image BIMG having the first depth DEP1.

In this embodiment, the second unit pixel PXU2 is controlled to display an image having a second depth DEP2. Referring to FIG. 11, the second unit pixel PXU2 may display the target image TIMG having the second depth DEP2.

In an embodiment, the first depth DEP1 and the second depth DEP2 are different from each other. However, embodiments of the present disclosure are not limited thereto. For example, the first depth DEP1 and the second depth DEP2 may be the same.

In an example, in an embodiment in which the first depth DEP1 is smaller than the second depth DEP2, the user may perceive the target image TIMG being located closer than the background image BIMG. For example, when the target image TIMG is an image of a person playing golf and the background image BIMG is an image of grass, the user may perceive the person playing golf in front of the grass. Accordingly, a more vivid image can be provided to the user.

In an example, in an embodiment in which the first depth DEP1 is larger than the second depth DEP2, the user may perceive the target image TIMG being located more distant than the background image BIMG. For example, when the target image TIMG is an image of a fish and the background image BIMG is an image of sea, the user may recognize as if the fish is in the sea. Accordingly, a more vivid image can be provided to the user.

In an embodiment, the image having the first depth DEP1 and the image having the second depth DEP2 are based on images photographed at different distances. For example, when the image having the first depth DEP1 is an image photographed at a short distance and the image having the second depth DEP2 is an image photographed at a long distance, the first depth DEP1 may be larger than the second depth DEP2. For example, when the image having the first depth DEP1 is an image photographed at a long distance and the image having the second depth DEP2 is an image photographed at a short distance, the first depth DEP1 may be smaller than the second depth DEP2.

In accordance with the embodiments of the present disclosure, a phenomenon can be reduced, in which the seam area SM is visible by the user.

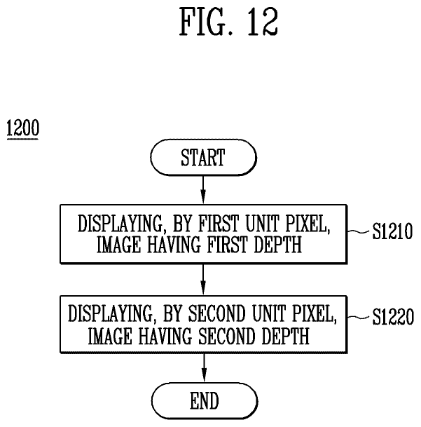

FIG. 12 is an embodiment of an image display method 1200 of the tiled display device in accordance with an embodiment of the present disclosure.

Referring to FIG. 12, the image display method 1200 of the tiled display device in accordance with an embodiment of the present disclosure includes step S1210 of displaying, by a first unit pixel, an image having a first depth and step S1220 of displaying, by a second unit pixel, an image having a second depth.

In the step S1210 of displaying, by the first unit pixel, the image having the first depth, the first unit pixel may display a background image having the first depth.

In the step S1220 of displaying, by the second unit pixel, the image having the second depth, the second unit pixel may display a target image having the second depth.

In an embodiment, the first depth is smaller than the second depth. In another embodiment, the first depth is equal to or greater than the second depth.

Further referring to FIG. 7, the host system HOST may control the first unit pixel to display the image having the first depth, and control the second unit pixel to display the image having the second depth. For example, the host system HOST may send first image data of the first depth to the first unit pixel and send second image of the second depth to the second unit pixel.

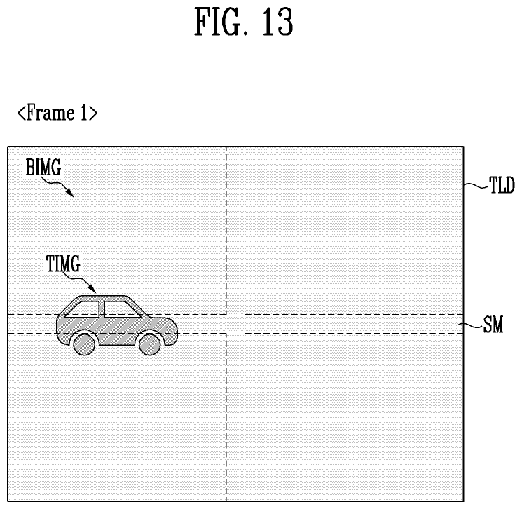

FIGS. 13 to 15 are views illustrating that an area in which a target image TIMG is displayed is changed according to progress of frames.

Referring to FIGS. 13 to 15, a moving image may be displayed in the tiled display device TLD. As the moving image is reproduced, an area in which a target image TIMG is displayed in the tiled display device TDL may be sequentially changed.

In the tiled display device TLD, a background image BIMG may be displayed in the other area except the area in which the target image TIMG is displayed.

Referring to FIGS. 4 and 13 together, the target image TIMG may be displayed at a left side of the tiled display device TLD in a first frame Frame 1. For example, the target image TIMG may be displayed in the first display device 410, the third display device 430, and the seam area SM between the first display device 410 and the third display device 430. The background image BIMG may be displayed in the other area of the first and third display devices 410 and 430, the second and fourth display devices 420 and 440, the seam area SM between the first display device 410 and the second display device 420, the other area of the seam area SM between the first and third display devices 410 and 430, the seam area SM between the second display device 420 and the fourth display device 440, and the seam area SM between the third display device 430 and the fourth display device 440.

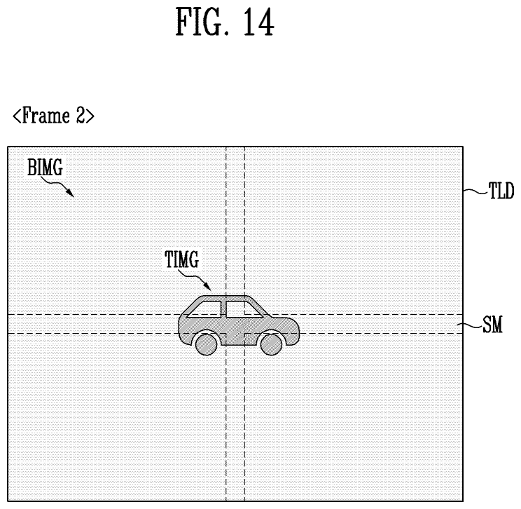

Referring to FIGS. 4 and 14 together, the target image TIMG may be displayed in a central area of the tiled display device TLD in a second frame Frame 2. For example, the target image TIMG may be displayed in the first to fourth display devices 410, 420, 430, and 440, the seam area SM between the first display device 410 and the second display device 420, the seam area SM between the first display device 410 and the third display device 430, the seam area SM between the second display device 420 and the fourth display device 440, and the seam area SM between the third display device 430 and the fourth display device 440. The background image BIMG may be displayed in the other areas of the first to fourth display devices 410, 420, 430, and 440. The background image BIMG may be displayed in the other areas of the seam area SM.

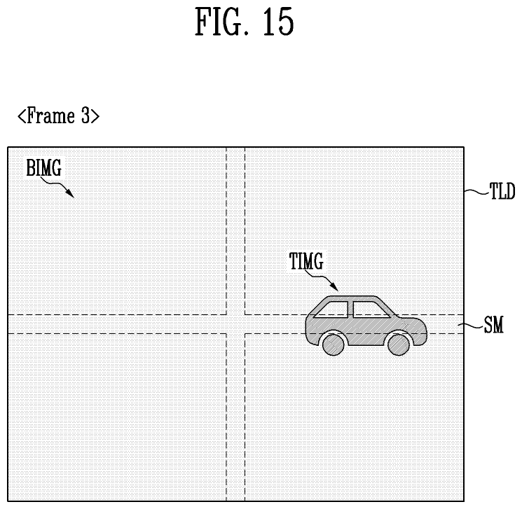

Referring to FIGS. 4 and 15 together, the target image TIMG may be displayed at a right side of the tiled display device TLD in a third frame Frame 3. For example, the target image TIMG may be displayed in the second display device 420, the fourth display device 440, and the seam area SM between the second display device 420 and the fourth display device 440. The background image BIMG may be displayed in the other area of the second and fourth display devices 420 and 440, the first and third display devices 410 and 430, the seam area SM between the first display device 410 and the second display device 420, the seam area SM between the first display device 410 and the third display device 430, the other area of the seam area SM between the second and fourth display devices 420 and 440, and the seam area SM between the third display device 430 and the fourth display device 440.

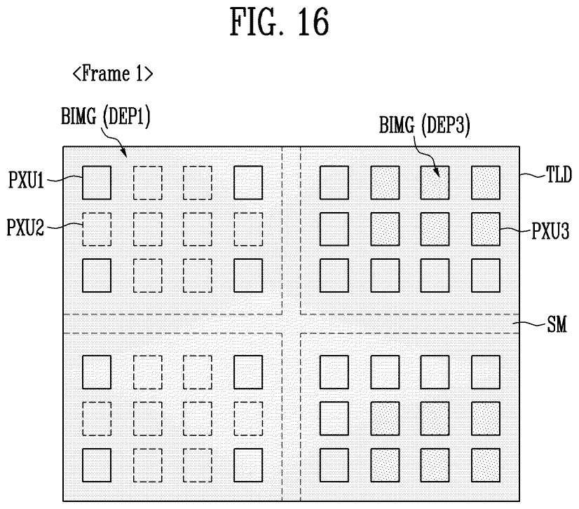

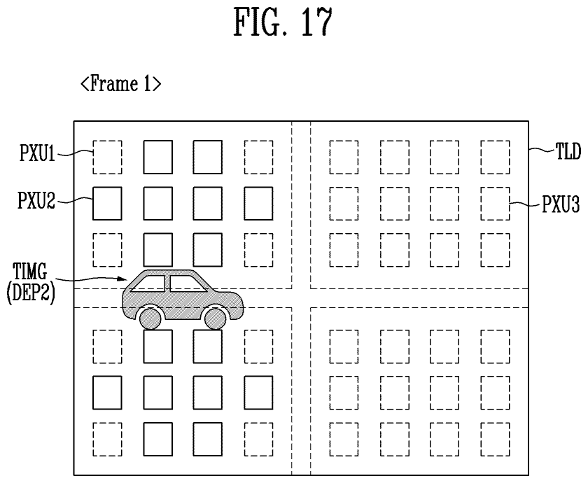

FIGS. 16 and 17 are views illustrating unit pixels displaying the background image BIMG and the target image TIMG in the first frame Frame 1.

Referring to FIGS. 16 and 17, the unit pixels may include a plurality of first unit pixels PXU1, a plurality of second unit pixels PXU2, and a plurality of third unit pixels PXU3.

In an embodiment, the first to third unit pixels PXU1, PXU2, and PXU3 have the same size. However, embodiments of the present disclosure are not limited thereto. For example, at least one of the first to third unit pixels PXU1, PXU2, and PXU3 may have a size different from a size of the other two.

The first unit pixel PXU1 may display a background image BIMG. In an embodiment, the first unit pixel PXU1 may include at least one pixel. In an embodiment, the first unit pixel PXU1 may include at least one sub-pixel.

The first unit pixel PXU1 may be located in a corner area or a vertex area of the display device 100 (see FIG. 4). In an embodiment, the first unit pixel PXU1 may be located in a central area of the display device 100.

The second unit pixel PXU2 may display a target image TIMG. In an embodiment, the second unit pixel PXU2 may include at least one pixel. In an embodiment, the second unit pixel PXU2 may include at least one sub-pixel.

The second unit pixel PXU2 may be located in a central area of the display device 100 (see FIG. 4). In an embodiment, the second unit pixel PXU2 may be located in a corner area or a vertex area of the display device 100.

The third unit pixel PXU3 may display a background image BIMG. In an embodiment, the third unit pixel PXU3 may include at least one pixel. In an embodiment, the third unit pixel PXU3 may include at least one sub-pixel.

The third unit pixel PXU3 may be located in an area spaced apart from the seam area SM in the display device 100 (see FIG. 4). For example, there may be pixel intervening between the third unit pixel PXU3 and the seam area SM. In an embodiment, the third unit pixel PXU3 may be located in a central area of the display device 100 and a corner area and/or a vertex area, spaced apart from the seam area SM.

In an embodiment, the first unit pixel PXU1 displays an image having a first depth DEP1. Referring to FIG. 16, the first unit pixel PXU1 may display part of the background image BIMG having the first depth DEP1.

In an embodiment, the second unit pixel PXU2 displays an image having a second depth DEP2. Referring to FIG. 17, the second unit pixel PXU2 may display part of the target image TIMG having the second depth DEP2.

In an embodiment, the third unit pixel PXU3 displays an image having a third depth DEP3. Referring to FIG. 16, the third unit pixel PXU3 may display part of the background image BIMG having the third depth DEP3.

In an embodiment, the first depth DEP1 and the third depth DEP3 are different from each other. In an embodiment, the third depth DEP3 is smaller than the first depth DEP1. For example, when the third depth DEP3 is 0, the third unit pixel PXU3 may display a planar image instead of a 3D image.

Further referring to FIG. 4, in an embodiment, any one of the plurality of display devices 410, 420, 430, and 440 include first and second unit pixels PXU1 and PXU2, and another of the plurality of display devices 410, 420, 430, and 440 include first and third unit pixels PXU1 and PXU3. For example, the first and third display devices 410 and 430 may include first and second unit pixels PXU1 and PXU2, and the second and fourth display devices 420 and 440 may include first and third unit pixels PXU1 and PXU3. For example, the first and third display devices 410 and 430 may include first and second unit pixels PXU1 and PXU2 without including any third unit pixels PXU3, and the second and fourth display devices 420 and 440 may include first and third unit pixels PXU1 and PXU3 without including any second unit pixels PXU2.

In an embodiment, in a display device including first and third unit pixels PXU1 and PXU3, the first unit pixel PXU1 may be disposed in an area adjacent to the seam area SM, and the third unit pixel PXU3 may be disposed in an area spaced apart from the seam area SM.

In accordance with embodiments of the present disclosure, a phenomenon can be reduced, in which the seam area SM is visible by the user.

In an embodiment, the background image BIMG displayed by the first unit pixel PXU1 and the background image BIMG displayed by the third unit pixel PXU3 may be identical or similar to each other. However, embodiments of the present disclosure are not limited thereto. For example, the background image BIMG displayed by the first unit pixel PXU1 and the background image BIMG displayed by the third unit pixel PXU3 may be different from each other.

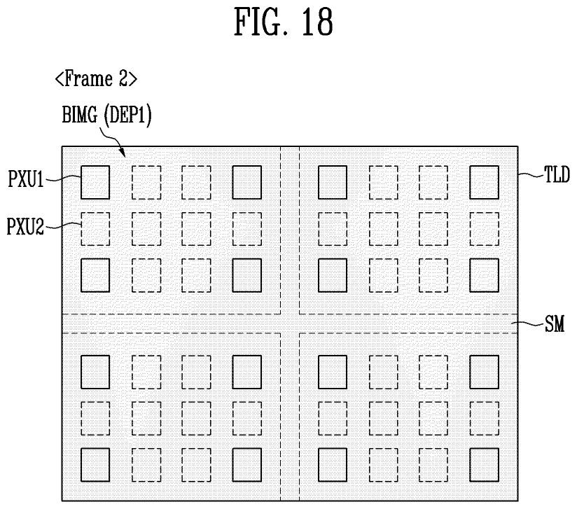

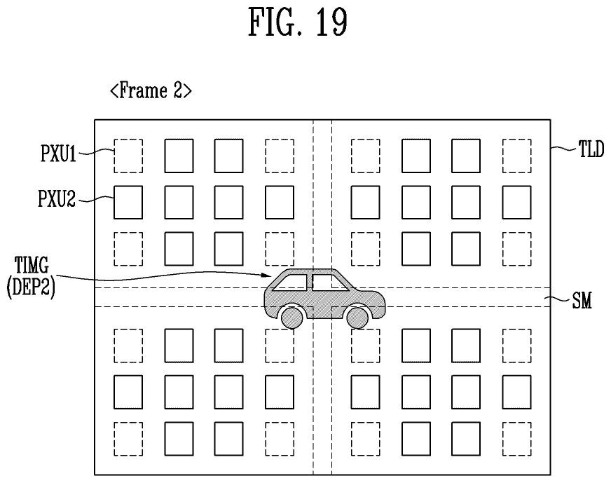

FIGS. 18 and 19 are views illustrating unit pixels displaying the background image BIMG and the target image TIMG in the second frame Frame 2.

As compared with FIGS. 16 and 17 described above, since the area in which the target image TIMG is displayed in the tiled display device TLD is changed, each of at least some of the plurality of third unit pixels PXU3 may be switched to the first unit pixel PXU1. Each of at least some of the others of the plurality of third unit pixels PXU3 may be switched to the second unit pixel PXU2. In addition, each of at least some of the plurality of first unit pixels PXU1 may be switched to the second unit pixels PXU2.

Further referring to FIG. 4, each of the third unit pixels PXU3 of the second and fourth display devices 420 and 440 may be switched to the first unit pixel PXU1 or be switched to the second unit pixel PXU2. In addition, each of at least one of the plurality of first unit pixels PXU1 of the second and fourth display devices 420 and 440 may be switched to the second unit pixel PXU2.

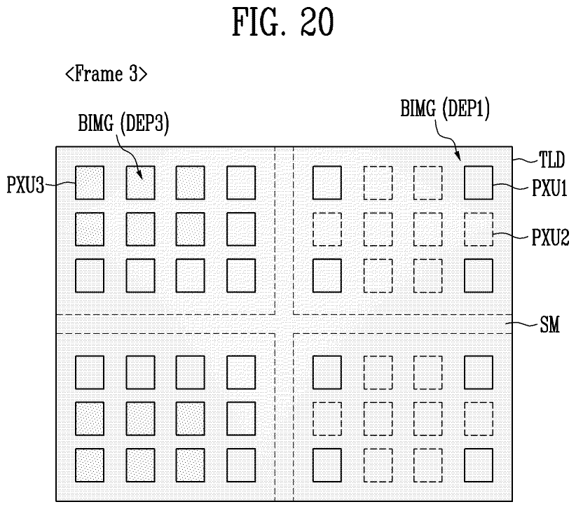

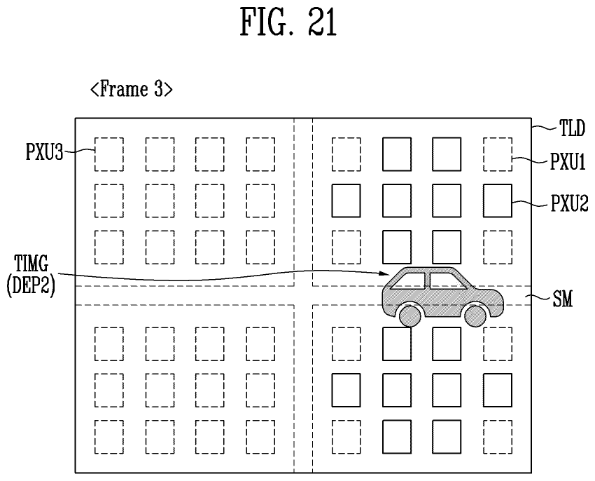

FIGS. 20 and 21 are views illustrating unit pixels displaying the background image BIMG and the target image TIMG in the third frame Frame 3.

Referring to FIGS. 20 and 21, the unit pixels may include a plurality of first unit pixels PXU1, a plurality of second unit pixels PXU2, and a plurality of third unit pixels PXU3.

As compared with FIGS. 18 and 19, since the area in which the target image TIMG is displayed in the tiled display device TLD is changed, each of at least some of the plurality of second unit pixels PXU2 may be switched to the first unit pixel PXU1. Each of at least some of the others of the plurality of second unit pixels PXU2 may be switched to the third unit pixel PXU3.

In an embodiment, the first unit pixel PXU1 may be switched to the third unit pixel PXU3. However, embodiments of the present disclosure are not limited thereto. For example, switching the first unit pixel PXU1 to the third unit pixel PXU3 may mean switching from outputting image data of a first depth DEP1 to a pixel to outputting image data of a third depth DEP3 to the pixel.

Further referring to FIG. 4, each of at least some of the second unit pixels PXU2 of the first and third display devices 410 and 430 may be switched to the first unit pixel PXU1. For example, switching the second unit pixel PXU2 to the first unit pixel PXU1 may mean switching from outputting image data of a second depth DEP2 to a pixel to outputting image data of a first depth DEP1 to the pixel. Each of at least some of the others of the second unit pixels PXU2 of the first and third display devices 410 and 430 may be switched to the third unit pixel PXU3. For example, switching the second unit pixel PXU2 to the third unit pixel PXU3 may mean switching from outputting image data of a second depth DEP2 to a pixel to outputting image data of a third depth DEP3 to the pixel. Each of at least some of the first unit pixel PXU1 of the first and third display devices 410 and 430 may be switched to the third unit pixel PXU3.

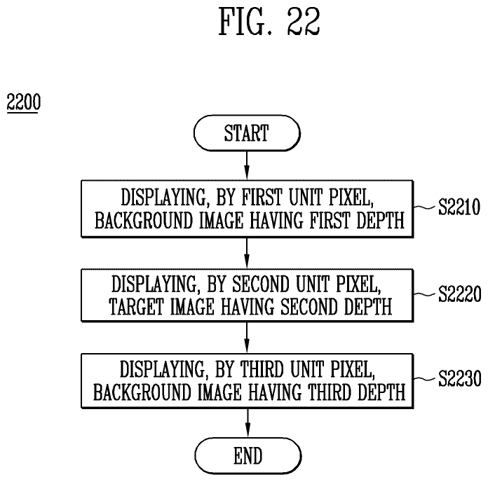

FIG. 22 is another example 2200 of the image display method of the tiled display device in accordance with an embodiment of the present disclosure.

Referring to FIG. 22, an image display method 2200 of the tiled display device in accordance with an embodiment of the present disclosure includes step S2210 of displaying, by a first unit pixel, a background image having a first depth, step S2220 of displaying, by a second unit pixel, a target image having a second depth, and step S2230 of displaying, by a third unit pixel, a background image having a third depth.

In an embodiment, the first depth, the second depth, and the third depth are different from one another. In an embodiment, the third depth is smaller than the first depth.

The background image displayed by the first unit pixel and the background image displayed by the third unit pixel may be similar to each other.

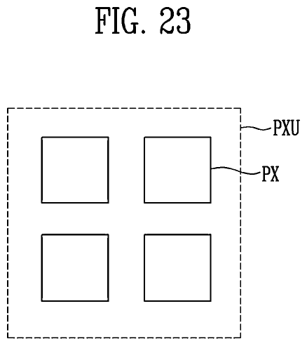

FIG. 23 is an embodiment of a unit pixel PXU.

Referring to FIG. 23, a unit pixel PXU in accordance with embodiments of the present disclosure may include at least one pixel PX.

In an embodiment, the unit pixel PXU may include one pixel PX. In an embodiment, the unit pixel PXU may include a plurality of pixels PX.

In an embodiment, the unit pixel PXU may be configured in a quadrangular shape. However, embodiments of the present disclosure are not limited thereto. For example, the unit pixel PXU may be configured in a square shape or be configured in a rectangular shape. However, embodiments of the present disclosure are not limited thereto. For example, the unit pixel PXU may be configured in a circular shape or be configured in a polygonal shape except the quadrangular shape.

In the tiled display device and the image display method thereof in accordance with the present disclosure, a phenomenon can be reduced, in which a seam area is visible.

Referring back to FIGS. 1 and 5, in an embodiment, a tiled display device includes the optical panel 110 and the display panel 120; the display panel 120 is divided into a first group of pixels (e.g., see PX1 of FIG. 5), a second group of pixels (e.g., see PX2 of FIG. 5), a third group of pixels (e.g., PX3 of FIG. 5), and a fourth groups of pixels (e.g., see PX4 of FIG. 5), where a seam area SM is disposed between these groups, and a controller of the tiled display device is configured output a background image to the pixels that are spaced apart from the seam area having a first depth and output a target image to the pixels that are adjacent the seam area having a second depth different from the first depth. For example, the pixels that are closest to the seam area SM may receive image data of the second depth and at least one of the pixels that are further from the seam area SM may receive image data of the first depth. For example, at least one intervening pixel may be present between the seam area SM and the pixel that is considered further from the seam area SM. While the seam area SM has been illustrated as being plus shaped when four groups of pixels, four display panels or four display devices are present, the seam area SM is not limited thereto. For example, when only two groups of pixels, two display panels or two display devices are present, the seam area SM may have a rectangular shape. In this example, the pixels within the two groups, the two display panels or the two display devices that are closest to the rectangular seam area SM may receive image data of the second depth and at least one of the pixels that are further from the rectangular seam area SM may receive image data of the first depth.

Example embodiments have been disclosed herein, and although specific terms are employed, they are used and are to be interpreted in a generic and descriptive sense only and not for purpose of limitation. In some instances, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure.

What is claimed is:

1. A tiled display device comprising:
a first unit pixel displaying a background image having a first depth on a seam area; and
a second unit pixel displaying a target image having a second depth different from the first depth.

2. The tiled display device of claim 1, further comprising a plurality of display devices,
wherein the seam area is located between the plurality of display devices, and
wherein at least one of the plurality of display devices includes the first unit pixel and the second unit pixel.

3. The tiled display device of claim 2, wherein each of the plurality of display devices comprises:
a display panel having a plurality of pixels; and
an optical panel located on the display panel, the optical panel including a plurality of lenses.

4. The tiled display device of claim 3, wherein each of the first unit pixel and the second unit pixel includes at least one of the plurality of pixels.

5. The tiled display device of claim 3, further comprising a host system configured to control the plurality of display devices,
wherein the host system is configured to:
control a pixel included in the first unit pixel among the plurality of pixels to display the background image having the first depth; and
control a pixel included in the second unit pixel among the plurality of pixels to display the target image having the second depth.

6. The tiled display device of claim 3, wherein at least one of the plurality of display devices includes a plurality of first unit pixels including the first unit pixel and a plurality of second unit pixels including the second unit pixel, and
wherein an average distance between the plurality of first unit pixels and the seam area is smaller than an average distance between the plurality of second unit pixels and the seam area.

7. The tiled display device of claim 2, further comprising a third unit pixel displaying a background image having a third depth different from the first and second depths in an area spaced apart from the seam area.

8. The tiled display device of claim 7, wherein another of the plurality of display devices includes the third unit pixel.

9. The tiled display device of claim 7, wherein the third depth is 0.

10. The tiled display device of claim 7, wherein a distance between the first unit pixel and the seam area is smaller than a distance between the third unit pixel and the seam area.

11. An image display method of a tiled display device, the image display method comprising:
displaying, by a first unit pixel of the tiled display device, a background image having a first depth on a seam area; and
displaying, by a second unit pixel of the tiled display device, a target image having a second depth different from the first depth.

12. The image display method of claim 11, wherein the tiled display device includes a plurality of display devices, and
wherein the seam area is located between the plurality of display devices.

13. The image display method of claim 11, wherein, in the displaying of the background image having the first depth, a host system controls a pixel included in the first unit pixel to display the background image having the first depth, and
wherein, in the displaying of the target image having the second depth, the host system controls a pixel included in the second unit pixel to display the target image having the second depth.

14. The image display method of claim 11, wherein the first depth is smaller than the second depth.

15. The image display method of claim 11, further comprising displaying, by a third unit pixel of the tiled display device, a background image having a third depth different from the first and second depths in an area spaced apart from the seam area.

16. The image display method of claim 15, wherein the third depth is

0.

17. A tiled display device comprising:
a display panel comprising a plurality of pixels;
a seam area disposed between first, second, third, and fourth groups of the pixels;
an optical panel disposed on the display panel; and
a controller configured to output a background image to the pixels that are spaced apart from the seam area having a first depth and output a target image to the pixels that are adjacent the seam area having a second depth different from the first depth.

18. The tiled display device of claim 17, wherein the seam area does not include any pixel.

19. The tiled display device of claim 17, wherein the optical panel includes at least one optical lens to enable the background image and the target image to be perceived as three-dimensional (3D) images.

20. The tiled display device of claim 17, wherein the first depth is smaller than the second depth.
